(19) United States
(12) Patent Application Publication
(10) Pub. No.: US 2006/0037892 A1
(43) Pub. Date: Feb. 23, 2006

(54) Apparatus for optically analyzing products such as fruit having indirect illumination

(76) Inventor: Philippe Blanc, Montauban (FR)

Correspondence Address: YOUNG & THOMPSON, 745 SOUTH 23RD STREET, 2ND FLOOR, ARLINGTON, VA, 22202, US

(21) Appl. No.: 11/203,182

(22) Filed: Aug. 15, 2005

(30) Foreign Application Priority Data
Aug. 17, 2004 (FR) 04 08921

(51) Int. Cl. G01N 29/00

(52) U.S. Cl. 209/577; 73/152.05; 73/152.41

(57) ABSTRACT

An apparatus for optically analyzing products such as fruit for automatic sorting, includes a device (1, 2) for conveying the products in a continuous line in a longitudinal direction, at least one station for optically analyzing the external surface of the products, a device for illuminating the products having at least one illumination chamber (30) through which the conveying device (1, 2) passes and which is provided with at least one light source (26, 28) arranged above the products and adapted to provide indirect illumination of the products by a diffuse light prevailing in the illumination chamber (30). At least one screen (27) is arranged between each light source (26, 28) and each conveying line (1, 2) to protect the products from debris that might originate from the light source (26, 28).

The invention relates to an apparatus for optically analyzing products such as fruit or vegetables so that they can be sorted automatically.

Already known are optical analysis apparatuses comprising:
a device for conveying the products in a continuous line in a longitudinal direction with respect to a fixed structure;
at least one station for optically analyzing the external surface of the products, comprising at least one imaging device fixed to the structure and having an optical axis oriented towards products transported past it by the conveying device;
a device for illuminating the products transported in line past each optical analysis station, formed by one or more lamps arranged above the conveying device and oriented towards the products in order to illuminate them (e.g. WO 01/01071). The images are memorized and analyzed by a processing unit (such as a computer) able to calculate data that can be used for sorting the products on the basis of these images and according to predefined programmed criteria. WO 9104803 also describes an apparatus for sorting fruit comprising a photographic unit formed by a box and having an opening positioned above the conveyor, the internal walls of which box are provided with a reflective material. Electric lamps are positioned close to the upper end of the rectangular box so as to emit light towards the corners of the box. In practice, such illumination devices present several series of problems.

Firstly, they illuminate principally only the upper faces of the products. Consequently, the illumination is not uniform or appropriate for producing images representing lateral and/or lower parts of the products. To mitigate this problem it has been proposed to equip the device with lateral light sources and/or mirrors. Nevertheless, such a solution is not satisfactory in that it is appropriate to avoid placing such relatively fragile optical and/or electrical elements in the aggressive and humid environment of the conveying device. In addition, the installation of these lateral optical elements poses a problem in view of the presence of other lateral mechanical elements of the conveying device which would also impair the quality of illumination.

Secondly, it has been found that the known illumination devices which illuminate the products strongly do not in practice allow the production of photographs permitting a fine analysis of variations in the brightness of the products.

Thirdly, the known illumination devices arranged closely above the products and radiating directly on to the products may cause surface heating of the latter which is liable to spoil them, particularly if they are highly perishable fruit such as peaches, pears, etc.

Fourthly, the known illumination devices are relatively fragile and are formed in part by glass parts liable to fracture. It can therefore happen that breakage of a lamp passes unnoticed and has the consequence that dangerous debris falls on to the products. This problem is posed acutely in the case of food products for which such debris constitutes a danger for the consumers, and is therefore not admissible. In this regard safety standards require the use of protective devices preventing any dangerous debris from falling on to food products.

It is therefore the object of the invention to propose an optical analysis apparatus capable of mitigating the above-mentioned disadvantages.

To achieve this object, the invention relates to an apparatus for optically analyzing products such as fruit for automatic sorting, comprising:
a device for conveying the products in a continuous line in a longitudinal direction with respect to a fixed structure;
at least one station for optically analyzing the external surface of the products, comprising at least one imaging device fixed to the structure and having an optical axis oriented towards the products transported past it by the conveying device;
a device for illuminating the products transported past each optical analysis station and extending longitudinally at right angles to each optical analysis station, wherein
the illumination device includes at least one illumination chamber through which at least one conveying line of the conveying device passes, each illumination chamber being provided with at least one light source adapted to provide indirect illumination of the products by a diffuse light prevailing in the illumination chamber;
at least one screen is arranged between each conveying line and each light source so as to protect the products carried by each conveying line from debris that might originate from said light source. Such a screen is adapted to prevent any direct illumination of the products by the light source or light sources.

More particularly, in an optical analysis apparatus according to the invention it is provided that it includes at least one light source arranged above the products carried by each conveying line and, between each conveying line and each light source arranged above said conveying line, at least one screen extending at least substantially vertically above said conveying line in its portion that passes through the illumination chamber so as to protect the products carried by each conveying line from debris that might fall from said light source arranged above said screen.

An optical analysis apparatus according to the invention advantageously includes for each conveying line a profile serving as a screen arranged at least substantially vertically above the conveying line.

More particularly, according to the invention the illumination device is advantageously adapted to provide only indirect illumination of the products by diffuse light. Thus, the light received by the products carried by the conveying device is light emanating indirectly, by reflection and diffusion, from each light source.

The inventor has found that such indirect illumination by diffuse light has numerous advantages in the context of the optical analysis of products with a view to sorting them automatically. Thus, the products can be illuminated uniformly on a plurality of faces with a diffuse light permitting fine analysis of the brightness of the products without surface heating of the products and in a manner compatible with the presence of a protective element interposed between the products and the light sources arranged above the products. All these advantages can be obtained in a simple and economical manner.

According to the invention, each light source is advantageously arranged above a screen. In other words, in an apparatus according to the invention all the light sources are arranged above the conveying device, and at least one screen is interposed between each light source and the conveying device located below it.

Each illumination chamber of an apparatus according to the invention advantageously includes walls forming a box defining the illumination chamber, the illumination chamber including at least one light source adapted to diffuse light towards at least one of the walls. In addition, according to the invention a screen is interposed between each light source and the products to prevent any direct illumination of the products by this light source and to capture any debris that might fall from the light source. The conveying device passes through the box parallel to the longitudinal direction.

In addition, according to the invention the box advantageously includes a wall extending above the conveying device and having a reflective and diffusing internal face so as to form a reflective and diffusing ceiling of the illumination chamber. This internal face reflects and diffuses the light emanating from the light sources contained in the illumination chamber. It is, for example, light-colored and matt. According to the invention each imaging device is advantageously arranged outside the illumination chamber(s) above the ceiling, the latter being provided (for each imaging device) with a through-aperture adapted to the field of vision of the imaging device so that the ceiling does not interfere with the field of vision.

According to the invention all the walls of the box delimiting an illumination chamber preferably and advantageously have a reflective and diffusing internal surface which, in particular, is light-colored and matt.

According to the invention at least one illumination chamber of the illumination device advantageously includes a plurality of opaque profiles fixed to the structure in the illumination chamber at a level located above that of the conveying device (each profile forming a screen protecting the products transported below the profile and preventing any direct illumination) and at a distance from one another, and each having a channel receiving a lighting tube arranged above the profile, in particular a neon-type tube or equivalent. The profiles and the lighting tubes are arranged below the ceiling which reflects and diffuses the light thereof towards the products. According to the invention each profile advantageously forms a reflector for the lighting tube that it accommodates in such a way as to guide the light emitted principally towards the ceiling. In this way, according to the invention the channel of each profile advantageously has a reflective and preferably non-diffusing upper surface (for example, of metal or metallized).

In addition, according to the invention at least one illumination chamber of the illumination device advantageously includes a plurality of lamps forming point light sources distributed in the illumination chamber at a level located above that of the conveying device and below the reflective and diffusing ceiling. According to the invention, the lamps are of the type having low-voltage halogen bulbs.

According to the invention, the lamps are advantageously arranged above the profiles accommodating the tubes. According to the invention each lamp is advantageously provided with a lower reflector and a bulb positioned above the reflector. In this way the lamp diffuses the light upwardly, i.e. towards the ceiling which reflects and diffuses it towards the products. In addition, the reflector collects any bulb debris, preventing it from falling on the products transported below the lamps. The profiles located below the bulbs collect any debris not captured by the reflectors as well any debris that might originate from the lighting tubes, thus preventing it from falling on to the products.

In addition, it is also advantageously provided in an apparatus according to the invention that the conveying device includes at least one line for conveying the products in a continuous line in a longitudinal direction with respect to the structure, each conveying line having a portion that passes longitudinally through at least one illumination chamber and comprises a plurality of individual supports for products aligned one behind the other in the longitudinal direction, and that a profile serving as a screen is mounted above the portion of each conveying line that passes through the illumination chamber. These profiles therefore protect the products carried by each conveying line located below them. In addition, according to the invention each screen, in particular each profile, arranged vertically above a conveying line advantageously has a non-reflective lower surface which, in particular, is dark-colored and matt. In this way, parasitic reflections of light towards the products by the lower faces of the profiles are avoided.

More particularly, according to the invention each screen, in particular each profile, arranged vertically above a conveying line advantageously has downwardly-inclined lateral flanks so as to cover the products carried by the conveying line, a cut-out being formed in the flank opposite each imaging device so that the flank does not interfere with the field of vision of the imaging device. The products carried through the illumination device by the conveying lines are thus completely protected and the risk of debris originating from the lamps or lighting tubes falling on the products is minimized.

Furthermore, it is advantageously provided in an apparatus according to the invention that the conveying device includes at least one line for conveying products transported in a continuous line in a longitudinal direction with respect to the structure, each conveying line having a portion that passes longitudinally through at least one illumination chamber and including a plurality of individual supports for products aligned one behind the other in the longitudinal direction, and that each imaging device is offset laterally with respect to a longitudinal vertical plane passing through the longitudinal direction of a conveying line and has an optical axis oriented towards the products carried by said conveying line, the optical axis being inclined with respect to the vertical.

It is also advantageously provided in an apparatus according to the invention that it has a plurality of imaging devices distributed on each side of and at the same distance from the longitudinal vertical plane and a plurality of successive optical analysis stations in the longitudinal direction, all the optical axes of the imaging devices forming the same angle of inclination α with respect to the vertical.

It is advantageously provided in the apparatus according to the invention that the angle of inclination α of the optical axes of the imaging devices with respect to the vertical is from 20° to 45°, in particular of the order of 36°.

In addition, an apparatus according to the invention advantageously includes, opposite each imaging device with respect to the conveying device, a wall forming a background for each photograph taken by said imaging device. Such a background, preferably dark-colored and matt, allows the contrast of the images taken to be enhanced and, in combination with the homogenous illumination of the products, contributes to facilitating the subsequent analysis of the images by the processing unit.

In addition, according to the invention the apparatus advantageously includes for each imaging device at least one reflector, called the lower lateral reflector, arranged beside and along the corresponding conveying line and adapted to enhance the illumination of a lower lateral surface zone of the products. It should be noted that the backgrounds and reflectors of the different imaging devices of the different successive analysis stations may be formed by flat walls extending along, beside and below the conveying line (perpendicularly to the optical axes of the opposed imaging devices), each of the walls having alternately in the longitudinal direction dark, matt portions to form a background, and portions that are reflective, or both reflective and diffusing, to form a reflector.

According to the invention, the illumination device advantageously includes a single illumination chamber through which each conveying line of the conveying device passes. In particular, according to the invention the conveying device advantageously includes at least two parallel conveying lines arranged substantially in the same horizontal plane and a single illumination chamber common to all the conveying lines and extending at right angles to each optical analysis station.

As a non-preferential variant, different illumination chambers for the conveying lines, and/or a plurality of illumination chambers in series in the longitudinal direction, for example, one for each analysis station, may be provided.

In addition, it is also advantageously provided in an apparatus according to the invention that each conveying line includes a plurality of rollers, each supported freely in rotation with respect to a transverse axis of rotation orthogonal to the longitudinal direction and spaced apart in the longitudinal direction in such a way that two successive rollers define between them an individual receptacle for supporting a product, and that it includes a device for driving the products in rotation adapted to drive the rollers in rotation about their axes between the analysis stations.

The invention also relates to an apparatus for optically analyzing products wherein there are provided all or some of the characteristics mentioned hereinbefore or hereinafter.

Other objectives, characteristics and advantages of the invention will be apparent from the following description of an embodiment of the invention given solely as a non-limiting example and with reference to the appended Figures, in which:

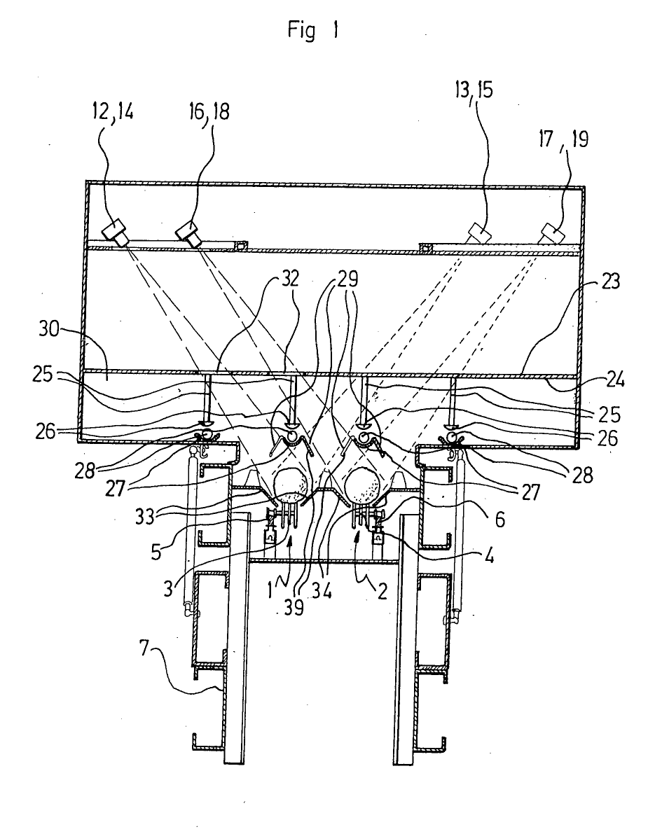

FIG. 1 is a schematic view in vertical cross-section of an optical analysis apparatus according to the invention;

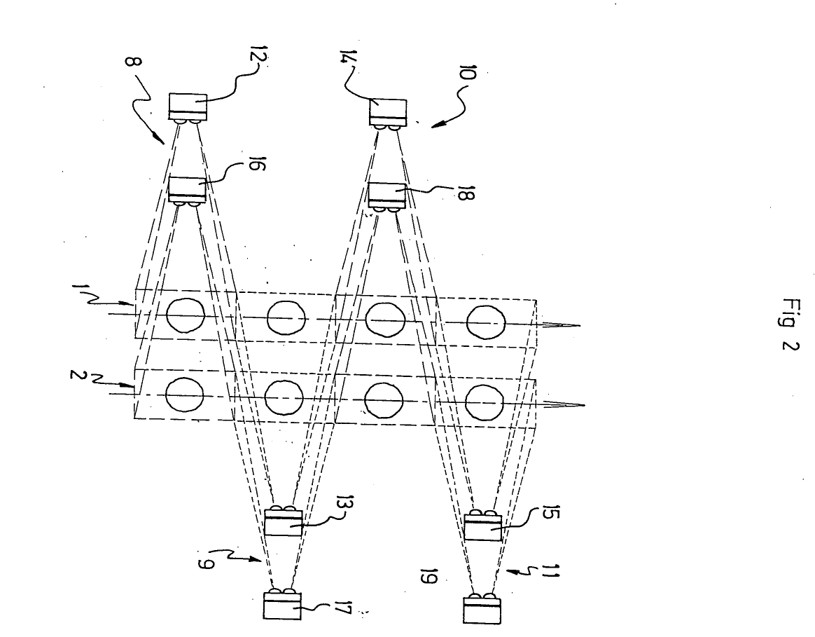

FIG. 2 is a schematic top view illustrating the arrangement of the imaging devices of the apparatus of FIG. 1;

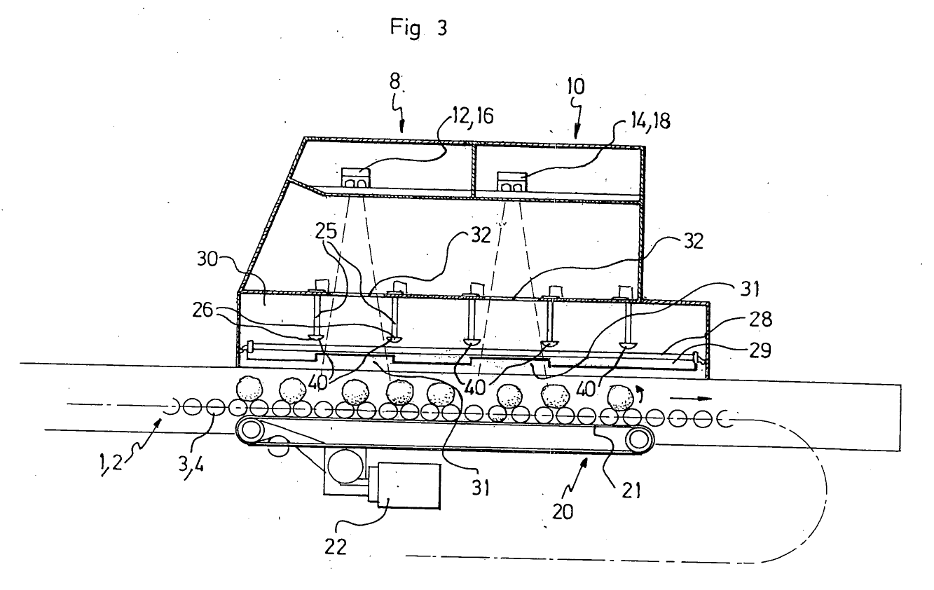

FIG. 3 is a schematic view in median longitudinal vertical section of the apparatus of FIG. 1 (the median profile interposed between the two conveying lines not being shown for reasons of clarity);

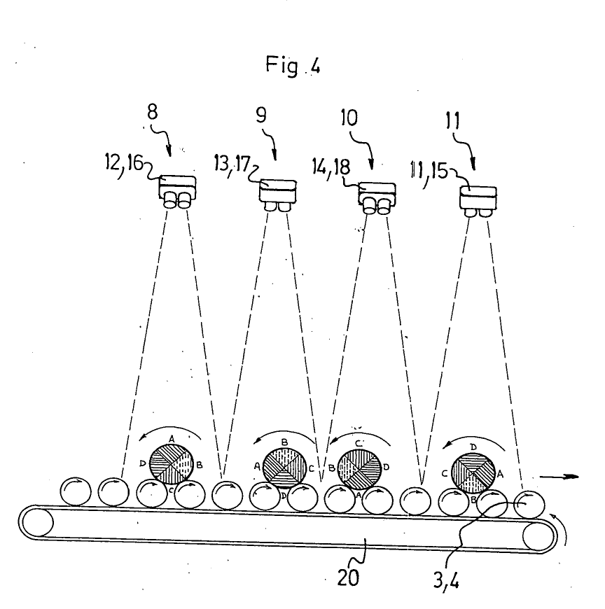

FIG. 4 is a schematic side view of the different analysis stations of the apparatus of FIG. 1 illustrating the rotation of a product between the first analysis station and the last analysis station;

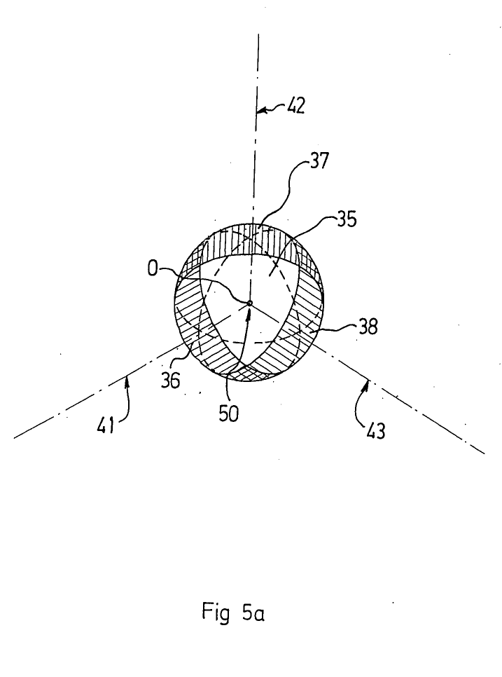

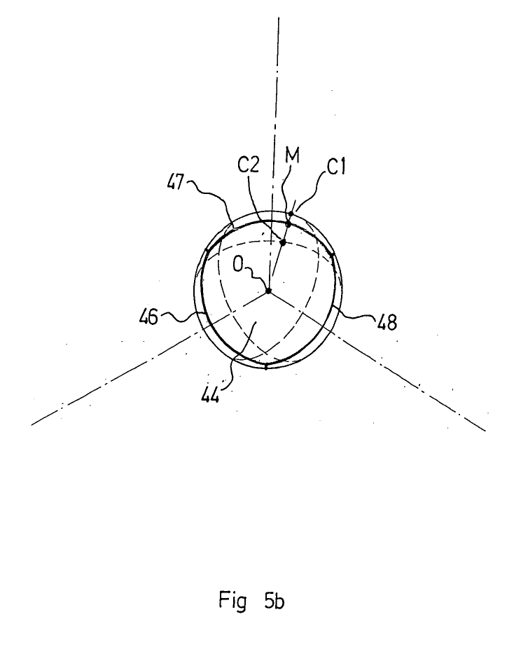

FIG. 5a it is a schematic diagram illustrating the different surface zones (spherical caps) of a product assumed perfectly spherical, as seen by the imaging devices of the apparatus of FIG. 1, and

FIG. 5b is a schematic diagram illustrating a surface zone of a product assumed perfectly spherical as seen by an imaging device of the apparatus of FIG. 1 and taken into account for the optical analysis.

The analysis apparatus according to the invention illustrated in the Figures is installed on a conveying device of products which, in the example shown, are spheroidal and may be formed by fruit or vegetables. Said conveying device includes two parallel conveying lines 1, 2. Each of the conveying lines 1, 2 includes a plurality of rollers such as 3, 4, each mounted freely in rotation about a transverse axis of rotation and spaced in such a way that two successive rollers define between them a receptacle for a product. The axes of rotation of the rollers are driven by an endless chain 5, 6 coupled to a motor device, such that the two conveying lines 1, 2 are driven continuously through the optical analysis apparatus. The assembly is carried by a structure 7 resting on the ground. Such conveying lines are of the type described, for example, in EP-527 519, or EP-670 276, or EP-1 000 883 or EP-1 040 058, to which reference may be made for further details.

The analysis apparatus according to the invention in the example illustrated in the Figures includes four analysis stations 8, 9, 10, 11 arranged successively at a distance from one another along the conveying lines 1, 2, i.e. in the longitudinal direction of each conveying line 1, 2.

Each analysis station includes two imaging devices, one imaging device 12, 13, 14, 15 having its optical axis oriented towards the first conveying line 1, and the other 16, 17, 18, 19 having its optical axis oriented towards the second conveying line 2. The optical analysis apparatus therefore includes, for each conveying line 1, four successive imaging devices, one imaging device for each analysis station.

The imaging devices are mounted on the structure 7 at a level situated above that of the conveying lines 1, 2 and are offset laterally with respect to the longitudinal direction of the corresponding conveying line 1, 2. Of the four imaging devices of each conveying line 1, 2, two imaging devices 12, 14 and 16, 18 respectively are arranged on one side of the longitudinal vertical plane containing the longitudinal direction of the respective conveying line 1, 2, and the two other imaging devices 13, 15 and 17, 19 respectively are arranged on the other side of the longitudinal vertical plane.

Thus, as the products are transported in line along a conveying line 1, 2, each product passes individually in succession in front of the four imaging devices, namely a first imaging device 12, 16 located on one side, a second imaging device 13, 17 located on the other side, a third imaging device 14, 18 located on the same side as the first, and a fourth imaging device 15, 19 located on the same side of the second.

Furthermore, as shown in FIG. 3, a drive device 20 having an endless belt 21 driven by a motor 22 is arranged below the conveying lines 1, 2 in the portion thereof which passes in front of the analysis stations 8 to 11, so as to drive in rotation the rollers 3, 4 of the conveying lines 1, 2, and therefore the products carried between said rollers. The speed at which the belt 21 is driven by the motor 22 is determined as a function of a predetermined reference diameter of the products transported by the conveying lines 1, 2.

With an apparatus according to the invention, this speed may be fixed during manufacture, the practical dimensional variations of the products with respect to a reference diameter being capable of being taken into account as explained, for example, in WO 01/01071.

The speed of the drive device 20 is preferably so adapted that each product having the predetermined reference diameter transported by a conveying line 1, 2 is subjected to a rotation about a horizontal axis orthogonal to the longitudinal direction of the corresponding conveying line 1, 2 having a value of the order of π/2 between two successive analysis stations 8, 9; 9, 10; 10, 11. This rotation is illustrated in FIG. 4, in which the cross-section of each product is shown divided into four complementary sectors A, B, C, D of π/2.

More generally, the product is subjected to a rotation of the order of 2π/P between two successive analysis stations, P being the total number of successive analysis stations in the longitudinal direction of the corresponding conveying line 1, 2.

Between two imaging devices 8, 10 or 9, 11 located on the same side of the conveying line 1, 2, the product is subjected to a rotation of the order of π in the example shown, i.e. more generally of the order of 2π/N1 and 2π/N2 respectively, N1 and N2 being the number of successive imaging devices located on the same side of the corresponding conveying line 1, 2. The imaging devices 12, 14 form a first lateral series of imaging devices all located on the same side of the longitudinal vertical plane of the conveying line 1 and extending successively parallel to the longitudinal direction of said conveying line 1. Likewise, the imaging devices 13, 15 constitute a second lateral series arranged on the side opposite to the first series formed by the imaging devices 12, 14. The imaging devices 16, 18 constitute the first lateral series of the conveying line 2 and the imaging devices 17, 19 constitute the second lateral series of the conveying line 2.

As can be seen in FIG. 1, the imaging devices are fixed to the structure 7 in such a way that their optical axes are oriented towards the corresponding conveying line 1, 2, and form an angle of from 20° to 45°, preferably of the order of 36°, with the median longitudinal vertical plane of said corresponding conveying line 1, 2.

The distance between the different analysis stations 8 to 11 in the longitudinal direction is preferably regular along the length of the analysis apparatus. For example, two successive analysis stations are separated by a distance that may be from 20 cm to 30 cm.

Each imaging device 12 to 19 preferably includes two cameras integrated in a single housing and adapted to produce photographs that are completely superposable, i.e. a camera in the visible region (RGB) and an infrared camera. These cameras are preferably of the type called “single-shot” cameras adapted to take of the order of 25 photographs per second or more. They supply digital data representing the images that can be transmitted to a data-processing unit capable of utilizing this data and programmed to this effect.

The analysis apparatus additionally includes a device for indirectly illuminating with diffuse light the products passing in front of the optical analysis stations. This illumination device includes an illumination chamber 30 having a horizontal wall 23 fixed to the structure 7 above the two conveying lines 1, 2 and having a reflective and diffusing lower face 24 covered with, for example, matt white paint. This wall 23 therefore forms a reflective and diffusing ceiling of the illumination chamber 30. The ceiling 23 carries a plurality of downwardly extending suspended elements 25 at the lower ends of which are fixed halogen lamps 26, their lower reflectors 40 being made, for example, of stainless steel or polished metal alloy, or being metallized, and being oriented in such a way as to shine upwardly, towards the lower face 24 of the wall 23, the bulbs of the lamps 26 being placed above the reflectors 40. In addition, four longitudinal profiles 27 extend between the lamps 26 and the level of the conveying lines 1, 2. These metal profiles 27 have a central longitudinal channel having a concave transverse cross-section the upwardly facing concavity of which receives luminous lighting tubes, for example, neon-type tubes 28 which are arranged above said channels. The profiles 27 have a reflective upper surface, in particular of polished metal alloy, for example stainless steel, or metallized, so that the light of the tubes 28 is reflected upwardly, i.e. towards the lower face 24 of the ceiling 23 which is itself reflective and diffusing.

The two central profiles 27 extend directly and vertically above the conveying lines 1, 2 and have a non-reflective lower surface 39 painted, for example, with matt black paint and downwardly-inclined lateral flanks 29 the function of which is to prevent any direct illumination of the products carried by the conveying lines 1, 2.

Thus, all the light sources 26, 28 are located above the conveying lines 1, 2 and are separated from the latter by the profiles 27 which serve as protective screens having the double function of collecting any debris that might fall from the light sources and therefore preventing it from falling on to the products transported on the conveying lines 1, 2 below them; and of additionally preventing any direct illumination of the products by light rays emanating directly from the light sources 26, 28. The reflectors 40 likewise serve as screens having this double function of collecting any debris originating from the lamps 26 and preventing it from falling on to the products, and of preventing any direct illumination of the products by the lamps 26.

The structure 7 also defines, between the horizontal wall 23 that forms a reflective and diffusing ceiling and the conveying lines 1, 2, an enclosed space within the illumination chamber 30, the internal surfaces of which enclosed space are preferably reflective and diffusing and, in particular, are all painted with matt white paint. This enclosed space is delimited by peripheral walls comprising the ceiling 23, longitudinal lateral walls and transverse end walls which form a box. The conveying lines 1, 2 pass through the illumination chamber 30 formed by this box in the longitudinal direction. When the halogen lamps 26 uniformly distributed in the illumination chamber 30 and the tubes 28 contained in the illumination chamber are lit, it will be understood that they diffuse light upwardly towards the horizontal upper wall forming the ceiling 23, which light is reflected and diffused softly to bathe the illumination chamber 30 in a homogeneous diffuse light having a wavelength corresponding to the wavelength emitted by the lamps 26 and the tubes 28.

It should be noted that the lateral flanks 29 of the central profiles 27 have cut-out portions 31 so as not to interfere with the field of vision of the imaging devices of the different analysis stations, i.e. to allow a photograph to be taken of the complete face of a product passing in front of such an imaging device. Likewise, the wall 23 forming the ceiling is provided with through-apertures 32 so as not to mask the field of vision of the imaging devices through them. The imaging devices 12 to 19 are fixed to the structure 7 above the ceiling 23 outside the illumination chamber 30, so as not to be illuminated and blinded by the light prevailing in said illumination chamber 30.

In addition, two lateral longitudinal flanks 33, 34 are arranged on each side of each conveying line 1, 2 opposite the imaging devices 12 to 19, in such a way as to be oriented towards the imaging devices 12 to 19 and to form an absorbent background, for example, painted with matt black paint, before which background the photographed product passes.

For each imaging device 12 to 19, the zone of the opposed flank 33, 34 (substantially orthogonal to the optical axis of the imaging device) which extends in the longitudinal direction opposite the optical axis and the field of vision is adapted to form a background (in particular matt black). By contrast, the zone of the other lateral flank 34, 33 which also extends in the longitudinal direction opposite the optical axis and the field of vision of the imaging device is reflective (metal or metallized), or reflective and diffusing (painted with matt white paint), so as to form a reflector enhancing the illumination of the lower lateral surface portion of the product.

In this way, each flank 33, 34 is adapted alternately in the longitudinal direction to form a background (matt black zone) and to form a reflector (matt white or metal or metallized).

The flank 33 of the conveying line 1 and the flank 34 of the conveying line 2, which are both arranged between the two conveying lines 1, 2, may be formed by the same central profile interposed between the two conveying lines 1, 2, as shown in FIG. 1.

The optical analysis apparatus according to the invention allows the production of uniform homogenous illumination of the fruit, which illumination is substantially identical for all the optical analysis stations. The different imaging devices 12 to 19 are inclined at the same angle with respect to the vertical and take photographs which are similar regarding the geometrical orientation of the image taken with respect to the product.

FIG. 5a shows schematically the different zones 35, 36, 37, 38 of a sphere that can be seen by the different successive imaging devices 12, 13, 14, 15 or 16, 17, 18, 19 as this sphere passes through the optical analysis apparatus according to the invention. The zones are hemispherical caps 35, 36, 37, 38. The optical axis 50 of the first imaging device 12 or 16 is assumed normal to the plane of FIG. 5a and above this plane. The path of this optical axis 50 is the centre O of the circle represented. The paths of the optical axes 41, 42, 43 of the three other imaging devices 13, 14, 15 or 17, 18, 19 are disposed at 120° to one another, the four optical axes 50, 41 to 43 being oriented in space to form a regular tetrapod and intersecting at the centre of the sphere. The three hemispherical caps 36, 37, 38 seen by these three other imaging devices are areas partially shown, with hatching parallel to the corresponding optical axis 41, 42, 43.

As can be seen, all portions of the product are seen and represented in the images taken, with a degree of overlap.

FIG. 5b shows with continuous lines the zone 44 of the hemispherical cap 35, seen in plan view in FIG. 5a, which is taken into account for the optical analysis. In each zone of overlap between the hemispherical cap 35 and one of the three other hemispherical caps 36, 37, 38, a portion of the median equatorial lines 46, 47, 48 at the equators of these two hemispherical caps is determined and memorized, and, for the optical analysis, the pixels of the photographs located outside the zone 44 delimited by these three median equatorial lines 46, 47, 48 are eliminated. In this way, the surface of the sphere is divided into four complementary zones all identical to the zone 44. Each median equatorial line 46, 47, 48 belongs to an internal bisectional equatorial plane of the equatorial planes containing the equators of the two caps 35 and 36 or 37 or 38 which overlap.

Each point M on this equatorial line is equidistant (on the surface of the sphere) from a point C1 belonging to the equator of the cap 35 and from a point C2 belonging to the other overlapping cap 36, 37, 38, the projections of these points C2, M, C1 on the plane of FIG. 5a belonging to the same radius R of the circle representing the cap 35. In the plane of FIG. 5a (corresponding to that of the image formed), the distance OM is a fraction of the radius R (equal to half the reference diameter). The position of point M is therefore represented by the relation OM/R.

In the analysis of a product which is not perfectly spherical, for each image taken by an imaging device that is considered (and which does not correspond to a perfectly hemispherical cap), the median limit of the zone to be considered (similar to zone 44) is determined by applying to the distance OC between O and the point C of the contour located in this radial direction, in each radial direction starting from the optical axis represented by point O, the same fraction OM/R as that obtained and memorized for the perfect sphere. The point M′ of the median limit on the flat image taken is therefore such that OM′=OC×OM/R. The programming logic of the processing unit on the basis of photographs of this kind can therefore be extremely simple and reliable, even in the case of distorted shapes.

All the imaging devices may be identical and all are arranged at an equal distance from the products carried by the conveying lines 1, 2.

It will be understood that such an optical analysis apparatus is extremely simple to install, to control and to maintain. The structure 7 forms an outer protective case provided with access covers for the different internal elements of the optical analysis apparatus according to the invention.

The signals emitted by the imaging devices are supplied to a processing unit (not shown) well-known per se in which the different images taken are memorized and which allows them to be subsequently processed and analyzed with a view to automatic sorting at a subsequent station of the product conveying device. The processing unit may be constructed in a manner known per se. It is advantageously formed by a data-processing device such as a personal computer.

It should be noted that the invention may be the subject of numerous variants with respect to the examples illustrated and described. For example, it is possible to provide more than two analysis stations on each side of a conveying line 1, 2. The number of analysis stations on each side may be different on one side than on the other. A value of 36° for the angle of inclination of the optical axes of the imaging devices with respect to the median longitudinal vertical plane is very advantageous in practice. It corresponds to the theoretically ideal angle of orientation of the optical axes whereby they coincide with the axes of a regular tetrapod centered on the centre of the sphere if the product is spherical. Nevertheless, other angle values may also be used. The number, type and arrangement of the light sources in the illumination chamber 30 may be different. Instead of a single illumination chamber, a plurality of illumination chambers may be provided, for example, different illumination chambers for the conveying lines and/or a plurality of illumination chambers arranged in series in the longitudinal direction, in particular one for each optical analysis station. The matt white paint may be replaced by other light-colored coatings, provided an effect of reflection and diffusion is obtained. Similarly, the matt black paint may be replaced by any dark coating able to form an appropriate background.

The drive device 20 may be adapted to drive the products in rotation either in the reverse direction with respect to their direction of transportation in the longitudinal direction, as shown in FIG. 3, or, on the contrary, in the forward direction.

1. Apparatus for optically analyzing products such as fruit for automatic sorting, comprising:
a device (1, 2) for conveying the products in a continuous line in a longitudinal direction with respect to a fixed structure (7);
at least one station (8, 9, 10, 11) for optically analyzing the external surface of the products, comprising at least one imaging device (12 to 19) fixed to the structure (7) with an optical axis oriented towards the products transported past it by the conveying device (1, 2);
a device (23 to 34) for illuminating the products being transported past each optical analysis station (8 to 11) and extending longitudinally at right angles to each optical analysis station (8 to 11),
wherein
the illumination device (23 to 34) includes at least one illumination chamber (30) through which at least one conveying line of the conveying device (1, 2) passes, each illumination chamber (30) being provided with at least one light source (26, 28) adapted to provide indirect illumination of the products by diffuse light prevailing in the illumination chamber (30);
at least one screen (27) is arranged between each conveying line (1, 2) and each light source (26, 28) in such a way as to protect the products carried by each conveying line from debris that might originate from said light source (26, 28).

2. Apparatus as claimed in claim 1, wherein it includes at least one light source (26, 28) arranged above the products carried by each conveying line (1, 2) and, between each conveying line (1, 2) and each light source (26, 28) arranged above said conveying line (1, 2), at least one screen (27) extending at least substantially vertically above said conveying line (1, 2) in its portion that passes through the illumination chamber (30), in such a way as to protect the products carried by each conveying line (1, 2) from debris that might fall from said light source (26, 28) arranged above said screen (27).

3. Apparatus as claimed in claim 2, wherein it includes, for each conveying line (1, 2), a profile (27) serving as a screen arranged at least substantially vertically above said conveying line (1, 2).

4. Apparatus as claimed in claim 1, wherein the illumination device (23 to 34) is adapted to provide only indirect illumination of the products by diffuse reflected light.

5. Apparatus as claimed in claim 1, wherein each illumination chamber (30) includes walls forming a box defining the illumination chamber (30), the illumination chamber (30) including at least one light source (26, 28) adapted to diffuse light towards at least one (23) of the walls.

6. Apparatus as claimed in claim 5, wherein the box includes at least one wall (23) extending above the conveying device and having a reflective and diffusing internal surface (24) so as to form a reflective and diffusing ceiling (23) of the illumination chamber (30).

7. Apparatus as claimed in claim 6, wherein each imaging device (12 to 19) is arranged outside the illumination chamber(s) (30) above the ceiling (23), the latter being provided with a through-aperture (32) adapted to the field of vision of the imaging device (12 to 19).

8. Apparatus as claimed in claim 5, wherein all the walls of the box delimiting an illumination chamber (30) have a reflective and diffusing internal surface.

9. Apparatus as claimed in claim 3, wherein at least one illumination chamber (30) of the illumination device includes a plurality of opaque profiles (27) fixed to the structure (7) in the illumination chamber (30) at a level located above that of the conveying device (1, 2) and at a distance from one another, and each having a channel receiving a lighting tube (28) arranged above the profile (27).

10. Apparatus as claimed in claim 9, wherein the channel of each profile (27) has a reflective upper surface.

11. Apparatus as claimed in claim 1, wherein at least one illumination chamber (30) of the illumination device includes a plurality of lamps (26) forming point light sources distributed in the illumination chamber (30) at a level located above that of the conveying device (1, 2) and below the reflective and diffusing ceiling (23).

12. Apparatus as claimed in claim 11, wherein each lamp (26) is provided with a lower reflector (40) and a bulb positioned above the reflector (40).

13. Apparatus as claimed in claim 1, wherein each light source (26, 28) is arranged above a screen (27).

14. Apparatus as claimed in claim 1, wherein the conveying device (1, 2) includes at least one line (1, 2) for conveying products transported in a continuous line in a longitudinal direction with respect to the structure (7), each conveying line (1, 2) having a portion that passes longitudinally through at least one illumination chamber (30) and including a plurality of individual supports for products aligned one behind the other in the longitudinal direction, and wherein the portion of each conveying line (1, 2) that passes through the illumination chamber (30) is surmounted by a profile (27) serving as a screen.

15. Apparatus as claimed in claim 1, wherein each screen (27) arranged vertically above a conveying line (1, 2) has a non-reflective lower surface (39).

16. Apparatus as claimed in claim 1, wherein each screen (27) arranged vertically above a conveying line (1, 2) has downwardly-inclined lateral flanks (29) so as to cover the products carried by the conveying line (1, 2), a cut-out (31) being formed in a flank (29) opposite each imaging device (12 to 19) so that this flank (29) does not interfere with the field of vision of the imaging device (12 to 19).

17. Apparatus as claimed in claim 1, wherein the conveying device (1, 2) includes at least one line (1, 2) for conveying products transported in a continuous line in a longitudinal direction with respect to the structure (7), each conveying line (1, 2) having a portion that passes longitudinally through at least one illumination chamber (30) and including a plurality of individual supports for products aligned one behind the other in said longitudinal direction, and wherein each imaging device (12 to 19) is offset laterally with respect to a longitudinal vertical plane passing through the longitudinal direction of a conveying line (1, 2) and has an optical axis oriented towards the products carried by said conveying line (1, 2), the optical axis being inclined with respect to the vertical.

18. Apparatus as claimed in claim 17, wherein it includes a plurality of imaging devices (12 to 19) distributed on each side of and at the same distance from the longitudinal vertical plane and a plurality of successive optical analysis stations (8 to 11) in the longitudinal direction, all the optical axes of the imaging devices (12 to 19) forming the same angle of inclination (α) with respect to the vertical.

19. Apparatus as claimed in claim 17, wherein the angle of inclination (α) of the optical axes of the imaging devices (12 to 19) with respect to the vertical is from 20° to 45°, in particular of the order of 36°.

20. Apparatus as claimed in claim 1, wherein it includes, opposite each imaging device (12 to 19) with respect to the conveying device (1, 2), a wall (33, 34) forming a background for each image taken by said imaging device (12 to 19).

21. Apparatus as claimed in claim 1, wherein it includes for each imaging device (12 to 19) at least one reflector, called the lower lateral reflector, arranged beside and along the corresponding conveying line and adapted to enhance the illumination of a lower lateral surface zone of the products.

22. Apparatus as claimed in claim 1, wherein the conveying device (1, 2) includes at least two parallel conveying lines (1, 2) arranged substantially in the same horizontal plane, and a single illumination chamber (30) common to all the conveying lines (1, 2) and extending at right angles to each optical analysis station (8, 9, 10, 11).

23. Apparatus as claimed in claim 1, wherein each conveying line (1, 2) includes a plurality of rollers (3, 4) each supported freely in rotation with respect to a transverse axis of rotation orthogonal to the longitudinal direction and spaced apart in the longitudinal direction in such a way that two successive rollers (3, 4) define between them an individual receptacle for supporting a product, and wherein it includes a device (20) for driving the products in rotation adapted to drive the rollers (3, 4) in rotation about their axes between the analysis stations (8 to 11).
